(19) United States
(12) Patent Application Publication
(10) Pub. No.: US 2005/0037795 A1
(43) Pub. Date: Feb. 17, 2005

(54) Method for saving power in radio frequency (rf) receiver and rf receiver

(76) Inventors: Janne Aaltonen, Turku (FI); Juha Salo, Lottoinen (FI); Ilkka Tahinen, Turku (FI); Pekka Talmola, Turku (FI)

Correspondence Address: MORGAN & FINNEGAN, L.L.P., 3 WORLD FINANCIAL CENTER, NEW YORK, NY, 10281-2101, US

(21) Appl. No.: 10/495,693

(22) PCT Filed: Nov. 16, 2001
(86) PCT No.: PCT/FI01/00996

(51) Int. Cl. H04Q 7/20

(52) U.S. Cl. 455/522

(57) ABSTRACT

The invention relates generally to a method and an arrangement (600) for reducing power consumption and an RF transmission arrangement and RF receiver. Particularly the invention relates to controlling and reducing power consumption in a radio receiver. The essential idea of the invention is to insert information to at least one symbol, which symbol is transferred in at least one transport stream packet. According to the invention the transport stream packets are sent to the receiver in predetermined order, and the order is informed to the receiver, whereupon the receiver can control power consumption with a transport stream packet level resolution. The receiver is advantageously arranged so that at least part of the receiver is turned off for a period during the time between receiving at least two transport stream packets. The invention may advantageously be applied in receiving arrangements of radio systems, wherein information is transferred in packets, such as a receiver of Digital Video Broadcasting (DVB) system.

### TECHNICAL FIELD OF THE INVENTION

The invention relates generally to a method and an arrangement for power consumption and an arrangement for RF transmission and RF receiver. Particularly the invention relates to controlling and reducing power consumption in a radio receiver.

### BACKGROUND OF THE INVENTION

In the following, DVB (Digital Video Broadcasting) system and DVB receivers are described as examples, but the use of the invention is not restricted only to the DVB system. Digital video broadcasting has been under development, and it is seen to gradually replace the analog broadcasting systems. This is because of its ability to offer new types of services, digital communication and better quality of service. Digital Video Broadcasting has been under standardisation by European Broadcasting Union (EBU) and European Telecommunications Standards Institute (ETSI) that have created, for example, DVB standard ETS 300 800. Moreover, the DVB standardisation pool includes other standard where digital broadcasting touched. In the digital broadcasting system data is transferred in transport, stream(s). In particular, data can be transferred as MPEG-TS based IP data. The modulation is e.g. Orthogonal Frequency Division Multiplex (OFDM) modulation.

FIG. 1 illustrates a solution 100 for delivering typical DVB-T broadcast according to the prior art. Typically a 8 MHz channel TV broadcast includes one transport stream packet (TS), which can have 4-5 channels (for example TV1, TV2, MTV3 and Nelonen 4 in Finland), which all have program identification (PID) number associated with them (such as 001, 002, 003, 004). In FIG. 1 one can see how the DVB-T transmissions are formed. There are 68 sequential symbols 1, 2, 68, which in 8 k system are 896 μs long each plus the length of guard interval which is 28 μs-224 μs. In 2 k system the lengths are ¼ of the length in 8 k system. Those 68 symbols form a frame 102 and four frames (282 symbols) form a super frame and thus one super frame has 4032 TS packets with transmission parameters 8 k/64QAM/2/3. For example, one symbol 1, 2, 68 comprises 14.8 TS packets, where a symbol is the smallest packet (quantum) of modulated DVB-T data.

With digital video broadcasting it is possible to achieve a good quality data transfer even if the receiver is mobile. The mobility provides user with the convenience of the flexibility of the reception. Therefore, the mobile applications of terrestrial DVB (DVB-T) will be important. However, the mobile DVB receivers should be small-sized and lightweight with small-sized batteries. Also, the available time of operation between charging the batteries should be long. In achieving this, the power consumption of mobile DVB receivers may become a problem.

A typical DVB receiver comprises tuner integrated circuits (IC's) and discrete amplifiers. Most of the present tuner IC's are operated with +5 V power supply, and if a low voltage battery is used there must be a step up converter for providing the +5 V voltage. However, the voltage of the battery may vary. For example, Li-Io battery providing +3,6 V voltage can also be applied in the present tuner IC. While the transmission of data consists of bursts, it would be possible to turn off the receiver or some parts of the receiver for a period of time between the bursts. That kind of solutions are described in patent documents U.S. Pat. No. 5,878,336 and U.S. Pat. No. 5,515,364.

However, there are certain problems related with applying these solutions in a DVB receiver. Firstly, the break between the data bursts has to be sufficiently long to overcome step-up converters and RF circuits settling time requirements. For example, turning on current, demodulators take approximately 100 symbols corresponding about 150 TS packets. In addition, video content according to the prior art solutions is in nature variable bit rate so it is difficult to predict when particular packet of video data will arrive and thus it is also difficult to predict when the current should be turned on.

A further problem is that in some cases the step up converters output voltage is not entirely dropped down, even if the step up converter is switched off. Therefore, the step up converter leftover voltage appears also in the RF circuits power supply, and RF circuits may not be entirely switched off.

### SUMMARY OF THE INVENTION

It is an objective of this invention to provide a receiving method and a receiver that offers solutions to the prior art problems. Especially, it is an object of this invention to provide a solution for reducing a power consumption of the receiver, and still to maintain stable receiving conditions and fast tuner lock-in time. In addition one of the object of the invention is to provide a method for controlling power consumption with packet level resolution.

The objects of the invention considering the power saving are fulfilled by turning a receiver at least partly off during the interval of a data reception. In addition, according to the invention, transport stream packets transferred are generated on transport stream generator for providing the predetermined period of the transport stream packets and symbols, whereupon the receiver can be informed about the periodicity of transport stream packets or symbols beforehand if necessary.

An embodiment of the invention is based on switching off the RF circuits connected to the step up converters, and still maintaining power in phase locked loop circuit or in at least a part of the phase locked loop. This is because tuner recovery from power-down to ready-to-receive-data time is mainly originated by the PLL control and lock-in time. According to the embodiment, during the time between the selected data stream packets the power is maintained in at least in some parts of the phase locked loop, while one or several other parts of the receiver are turned off for a certain time period. If there are no selected data to be received for a longer time, then even the phase locked loop is advantageously turned off.

With an embodiment of the invention transferred transport stream packets can be generated so that selected transport stream packet, such as for example PID 1 transport stream packet, is sent periodically, for example, so that every 10^{th} packet is selected transport stream packet, whereupon the receiver is arranged to be on only during to receiving these desired packets. In that situation the receiver can be informed about the periodicity beforehand, advantageously once if the periodicity does not change. That kind of packet level power scheme could be utilized after RF and other OFDM modulator parts of the receiver. At other times particular parts of the receiver can be turned off for saving power. With another embodiment of the invention the selected transport stream packets can be sent also in other predetermined order, such as time based order or order based on data content.

According to the embodiment of the invention the receiver is informed about the periodicity or about the other predetermined order of delivered transport stream packet for example by related data in service information (SI). Another way according to the embodiment of the invention is that the receiver finds or detects the periodicity automatically, such as using an intelligent algorithm. When the receiver detects the periodicity or it is informed about the periodicity, the receiver is able to lock-in to the periodicity. In addition the period of the transport stream packets and/or symbols, where certain information is located, can also be communicated to the receiver by other datagrams or on interaction channel. However, the periodicity is advantageously communicated once to the receiver at the beginning of the data transferring process and then only if the periodicity will change.

In the implementation the phase locked loop circuit can be powered directly from the stabilised low voltage battery. The demodulator may also use this voltage. RF circuits supply voltage is provided by the step up converter and can therefore be switched off during the break between the selected data stream packets. During the step up converter switch off, the phase locked loop circuit maintains the power from the battery. The demodulator may also be switched off during the period by e.g. controlling an internal switch off function. Voltage controlled oscillator tuning voltage is created by using another step up converter. Tuning voltage may also be switched off during the break, if the settling time is sufficiently short.

It is characteristic to a method according to the invention for controlling power consumption in a radio receiver for receiving transport stream packets, wherein selected transport stream packets are transferred to said receiver in predetermined order, that
power of at least part of the receiver is turned off for a period during the time between at least two selected transport stream packets, and
said receiver is informed about when to receive at least one of the following selected transport stream packets.

The invention also applies to an arrangement for controlling power consumption in a radio, receiver for receiving transport stream packets, wherein the arrangement comprises radio transmitting arrangement and radio receiver and means for transferring selected transport stream packets to said radio receiver in predetermined order, which is characterised in that the arrangement comprises
means for turning off power of at least part of the receiver for a period during the time between at least two selected transport stream packets, and
means for informing said receiver about when to receive at least one of the following selected transport stream packets.

The invention also applies to a radio transmission arrangement for generating transport stream packets and transferring them to a receiver, wherein a radio transmission arrangement comprises means transferring for selected transport stream packets to said receiver in predetermined order, which is characterised in that the radio transmission arrangement comprises
means for informing said receiver about the order, when to receive at least one of the following selected transport stream packets.

In addition the invention also applies to a radio receiver for receiving transport stream packets, wherein said radio receiver is arranged to receive selected transport stream packets in predetermined order, which is characterized in that the radio receiver comprises
means for receiving information about when to receive at least one of the following selected transport stream packets, and
means for turning off power of at least part of the receiver for a period during the time between at least two selected transport stream packets.

In accordance with another aspect of the invention there is provided a computer program product for controlling power consumption in a radio receiver for receiving transport stream packets, wherein selected transport stream packets are transferred to said receiver in predetermined order, comprising:
computer program code for turning off power of at least part of the receiver for a period during the time between at least two transport stream packets, and
computer program code for informing said receiver when to receive at least one of the following selected transport stream packets.

Advantageously, the computer program code can be a hardware (Digital Signal Processing), firmware or software implemented in the receiver or in the receiver arrangement.

The one preferred embodiment of the invention is considered to be a use of transport stream generation providing the predetermined period of the selected transport stream packets and symbols and informing the receiver about the periodicity by service information, whereupon at least one or several other parts of the receiver are turned off for a certain time period between the selected data stream packets.

Other preferred embodiments of the invention are presented in dependent claims.

The term “phase locked loop” (PLL) is often understood to include the controlled oscillator for producing the output signal. However, in this context, a “phase locked loop” is considered to include the control parts, and the controllable oscillator is not considered be included in the term. This definition is due to the fact that the oscillator is advantageously located in an integrated circuit together with the mixer, while the control parts are located in a separate integrated circuit.

Some embodiments of the invention are described in the dependent claims.

### BRIEF DESCRIPTION OF THE DRAWINGS

Next the invention will be described in greater detail with reference to exemplary embodiments in accordance with the accompanying drawings, in which:

FIG. 1 illustrates a schematic chart of a solution for delivering typical DVB-T broadcast according to the prior art,

FIG. 2 illustrates a flow diagram of an exemplary method for transferring data according to the present invention,

FIG. 3 illustrates a flow diagram of an exemplary method for receiving data according to the present invention,

FIG. 4 illustrates a schematic chart of an exemplary arrangement for a radio transmitter according to the present invention,

FIG. 5 illustrates an example of a power supply arrangement of a receiver according to the present invention,

FIG. 6 illustrates a schematic chart of an exemplary arrangement for a radio receiver according to the present invention, and

FIG. 7 illustrates a schematic chart of an exemplary arrangement for controlling power consumption in a radio receiver according to the present invention.

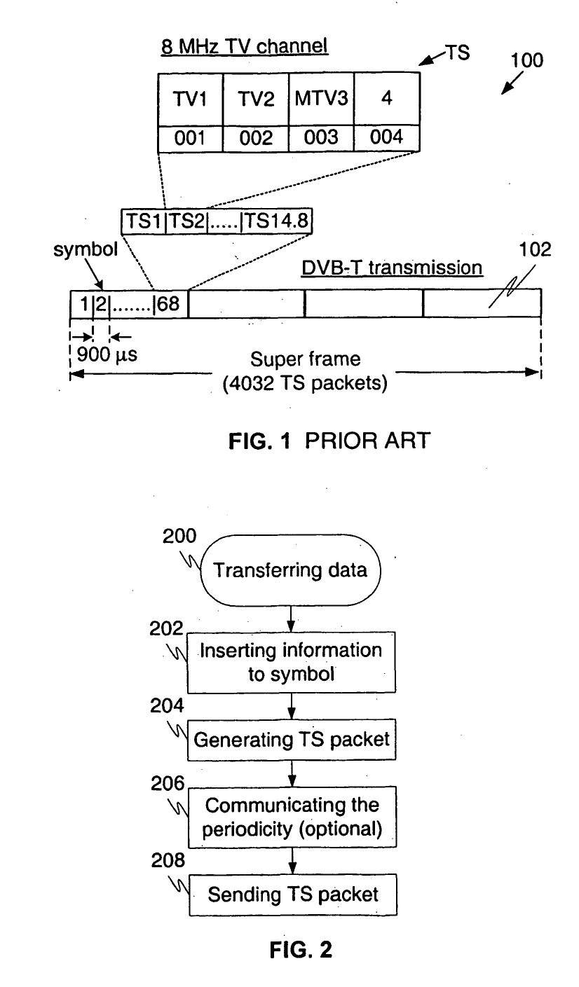

### DETAILED DESCRIPTION

FIG. 2 illustrates a flow diagram of an exemplary method 200 for transferring data according to the invention. A radio transmission arrangement inserts information deliberately to symbols or group of symbols in step 202. In practice the radio transmission arrangement forms in step 204 n·14.8 transport stream packet groups, where n is an integer. With an exemplary embodiment of the invention the receiver may want to receive particular information, such as only certain data of one TV channel or the like, whereupon the radio transmission arrangement can arrange information desired by the receiver to the symbols and/or transport stream packets according to the invention so that order of the transferred symbols and/or transport stream packets can be determined beforehand. The predetermined order of the transferred symbols and/or transport stream packets may be periodic, when the selected symbol and/or transport stream packet may be for example every 10^{th} symbols and/or transport stream packets. The period may also be time based and/or based on data content.

The step 206 in the data transferring process is optional and it is performed, for example, once or when it is necessary. The step 206 may be performed in situations, for example, when the periodicity will change. However, in step 206 the radio transmission arrangement may communicate the order or period of selected symbols and/or transport stream packets, where certain information is located, to the receiver. With an embodiment of the invention the order or periodicity may be communicated to the receiver by sending a datagram where the predetermined order or periodicity is disclosed. The order or periodicity may also be communicated to the receiver by related data in service information (SI) or sending data concerning the order or periodicity through an interaction channel. However, the communicating the order or periodicity of the transferred symbols and/or transport stream packets is optional and the periodicity is preferably communicated to the receiver only once at the beginning of the data transfer process. Advantageously the periodicity may be communicated to the receiver also at other times, for example, if the periodicity will change. However it has to be noticed that according to the one embodiment of the invention it is not necessary to communicate the periodicity to the receiver at all because the receiver may also find or detect the periodicity by using an intelligent algorithm.

The radio transmission arrangement transfers the transport stream packets and/or symbols in step 208. According to the invention the radio transmission arrangement can be arranged to operate in a mode, where it transfers the selected symbols and/or transport stream packets in predetermined order or period in order that the receiver can be at least in partly turned off during the interval between to receiving the selected symbols and/or transport stream packets.

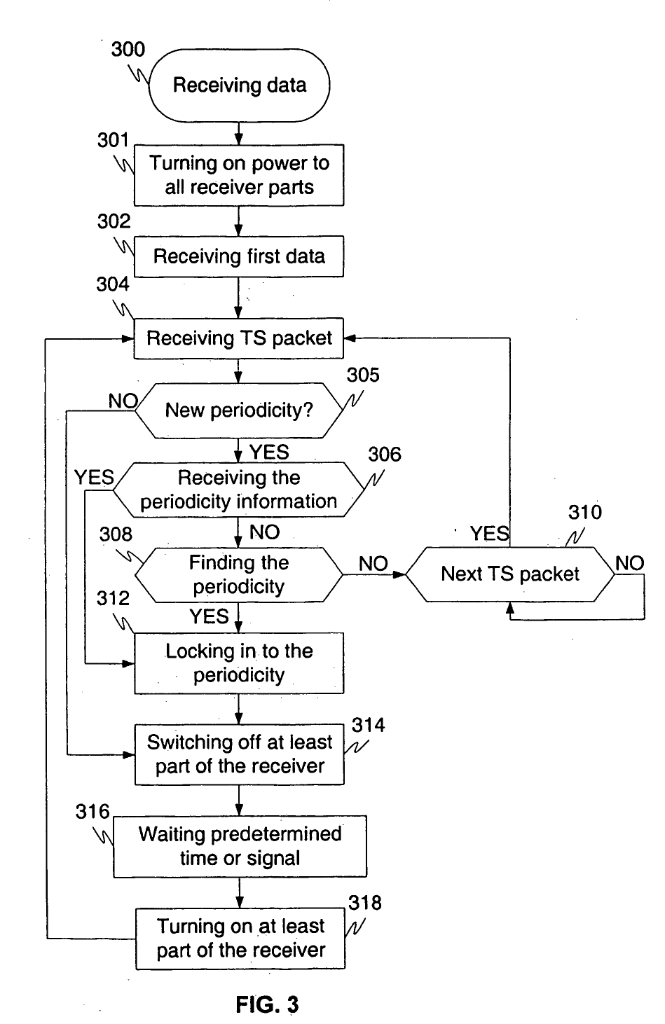

FIG. 3 illustrates a flow diagram of an exemplary method 300 for receiving data according to the one embodiment of the invention. At first the receiver may be in stand-by mode or in some other energy save mode known in prior art so that some part of the receiver is turned off, whereupon all the receiver parts is advantageously turned on in step 301 when there is a data transmission to be received, 302. A transport stream packet can then be received in step 304, after which the possible periodicity information is received in step 306. The possible periodicity information is checked in step 305. If the periodicity information is received in step 306 the receiver may perform the step 312 and lock-in to the periodicity. If the periodicity is not informed the receiver may try to find or detect the periodicity automatically, for example, by using an intelligent algorithm in step 308. If the receiver detects the periodicity it can perform the step 312 and lock-in to the periodicity and if the periodicity is not found the receiver may stand on step 310 and wait next transport stream packet to be received in step 304. If there is no information about the new periodicity in step 305 the step 314 may advantageously performed. With an embodiment of the invention the receiver can also be arranged to wait next transport stream packet for example for a certain time and after this switch off at least part of the receiver.

When the receiver is locked-in to the periodicity in step 312, or the periodicity is known from earlier steps, at least part of the receiver may be switched off in step 314, after which the receiver can wait predetermined time or signal in step 316. After predetermined time at least part of the receiver is turned on in step 318 for receiving next transport stream packet in step 304. Also receiving a certain signal may cause a turning on process performed in step 318. However, in this situation there must be powered part in the receiver for receiving the certain signal causing a turning on process of the receiver.

It has to be noticed that the steps 306-312 is optional so if there is no information about the new periodicity in step 305 the receiver may next perform the step 314 after the step 305 and switch off at least part of the receiver. Advantageously the receiver performs one of the steps 306, 308 or 312 only once at the beginning of the data receiving process 300 and after logging-in to the periodicity in step 312 the receiver performs only the steps 304, 314, 316 and 318. It is also possible in accordance with one embodiment of the invention that if the receiver is informed about the change of the periodicity in step 305, for example by related data in service information (SI), the receiver may perform the step 306 and/or 308 for finding out the new periodicity and logging-in to this new periodicity.

Also it has to be noticed that at least part of the steps 304-318 in the flow diagram illustrated in FIG. 3 may be performed as loop. Also the order of the steps is not restricted to the order illustrated in FIG. 3.

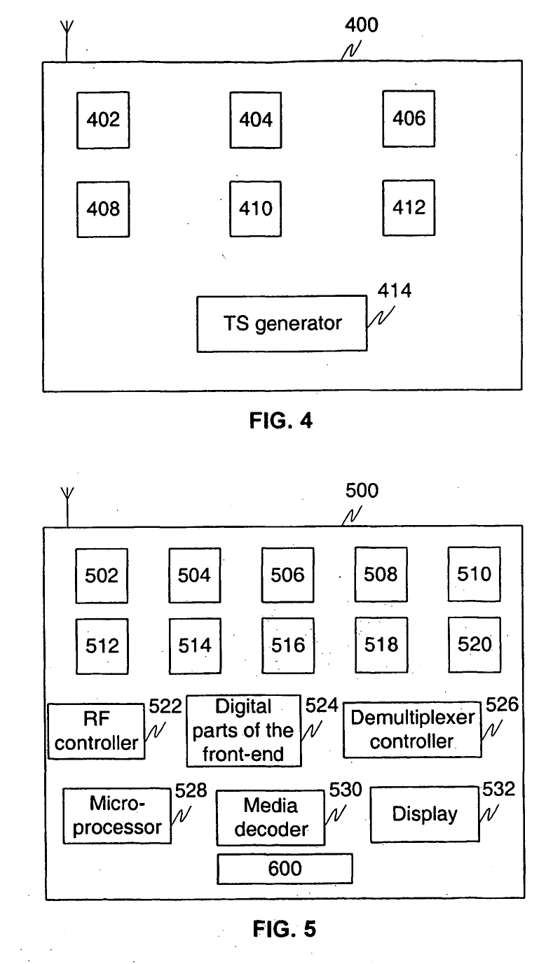

FIG. 4 illustrates a schematic chart of an exemplary arrangement 400 for a radio transmitter, such as for example a DVB-T transmitter, according to the invention, where the radio transmitter 400 is arranged to generate and send transport stream packets and/or symbols in a certain order. The radio transmitter 400 comprises at least essential means known by person skilled in the art for transmitting radio broadcast. In addition the radio transmitter 400 according to the invention may comprise means 402 for receiving possible query from the receiver to send certain data to the receiver and means 404 for generating predetermined order to send the selected transport stream packets and/or symbols including desired data in certain moment and means 406 for sending the selected transport stream packets and/or symbols in predetermined order.

In addition the radio transmitter 400 also comprises means 408 for informing the receiver about the predetermined order or the periodicity of the selected and transferred transport stream packets and/or symbols by related data in service information (SI). The radio transmitter 400 can also comprise means 410 and/or means 412 for informing the receiver about the predetermine order or the periodicity by datagram or interaction channel, respectively. According to the invention the generation of transport stream packets and/or symbols is advantageously managed on a particular transport stream generator 414 on the radio transmitter.

FIG. 5 illustrates a schematic chart of an exemplary arrangement 500 for a radio receiver according to the invention, where the radio receiver 500, such as for example a DVB-T receiver, is arranged to receive radio transmission and also to control power consumption. The radio receiver 500 comprises at least essential means known by person skilled in the art for receiving radio broadcast.

With an embodiment of the invention, the RF signal is received from the radio interface with an antenna, and the received signal is amplified in an RF amplifier. The signal is then filtered with a controllable-frequency pass-band filter, and again amplified in a controllable-gain an AGC (Automatic Gain Control) amplifier. After filtering with pass-band filters the signal is led to a mixer. A voltage controlled oscillator provides a local oscillator signal to the second input of the mixer. An intermediate frequency signal from the mixer output can be amplified and filtered with a narrow-band pass-band filter. The filtered signal can be amplified with an IF amplifier, which gives a feedback control signal for the AGC amplifier. The amplified IF signal can be led to a demodulator that demodulates the intermediate frequency signal into a transport bit stream corresponding to the information that has been modulated into the RF signal. The demodulator may include several functional blocks, such as an Analog-to-Digital converter AD, a Fast Fourier Transformer FFT, Forward Error Correction unit FEC, a channel correlation unit CH. COR., a channel estimator CH. EST., an AGC unit, an interface for a I2C bus, and an output buffer for the transport stream TS OUT.

The synthesizer of the receiver comprises a PLL (Phase Locked Loop), which controls the VCO (Voltage Controlled Oscillator), the output signal of which is amplified by the amplifier in order to generate the output signal for the PLL.

The radio receiver 500 according to the invention comprises means 502 for receiving transport stream packets and/or symbols and means 504 for receiving information concerning the order of the selected transport stream packets and/or symbols. The radio receiver 500 may also comprise means 506 for sending possible query or the like to the radio transmitter for sending a desired or selected data to the receiver. The radio receiver 500 comprises also means 508 for receiving information about the predetermined order or the periodicity of the selected and transferred transport stream packets and/or symbols by related data in service information (SI). The radio receiver 500 can also comprise means 510 and/or means 512 for receiving information about the predetermined order or the periodicity by datagram or interaction channel, respectively.

In addition with an embodiment of the invention the radio receiver 500 comprises means 514 for controlling power of at least part of the receiver, such as for example RF controller 522, digital parts of the front-end 524, demultiplexer controller 526, microprocessor 528, media decoder 530, display 532 or other peripherals. The power controlling means 514 can comprise means 516 for turning on/off power of said part of the receiver or the means 514 are alternatively arranged to operate with means 516. The radio receiver comprises also a power supply 600.

Further the radio receiver 500 according to the present invention advantageously comprises means 518 for detecting the periodicity of the transport stream packets and/or symbols to be received automatically. The radio receiver 500 can be arranged to use for example an intelligent algorithm for detecting the periodicity. Typically the radio receiver 500 comprises also means 520 for locking-in to the periodicity.

The power controlling means 514 may be implemented for example by a computer program product comprising computer program code for turning off power of at least part of the receiver for a period during the time between at least two transport stream packets. The computer program product may comprise also computer program code for informing said receiver when to receive at least one of the following selected transport stream packets. Advantageously, the computer program code can be a hardware (Digital Signal Processing), firmware or software implemented.

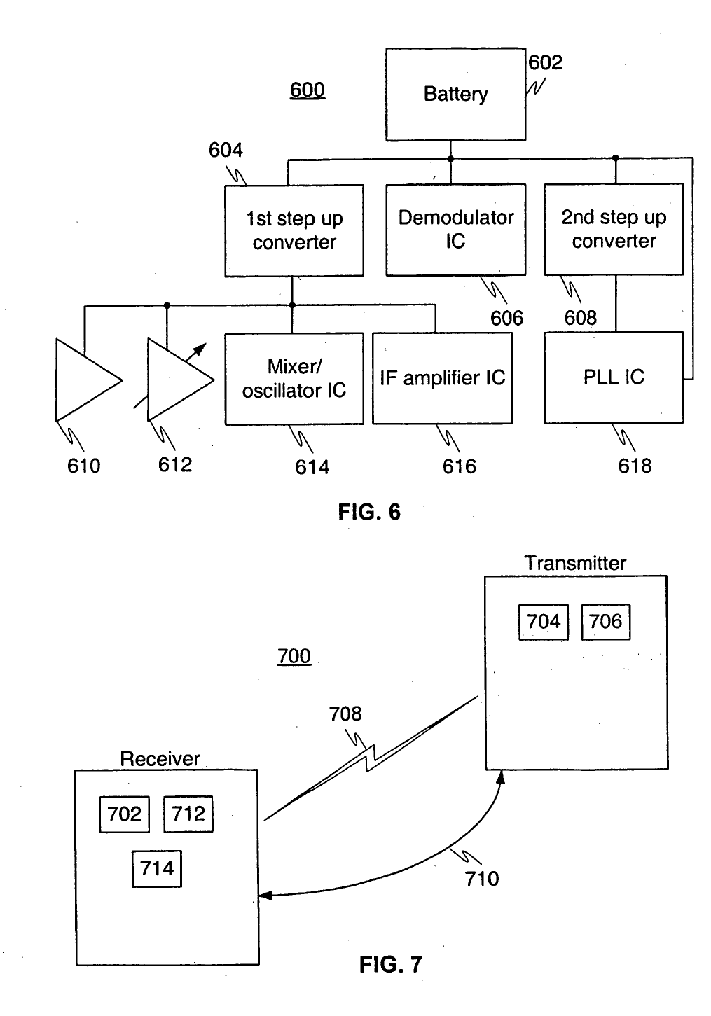

It has to be noticed that the means and/or components described above, such as for example an RF amplifier, AGC and filters, may also be a part of a power supply arrangement of the radio receiver illustrated in FIG. 6.

FIG. 6 illustrates an example of a power supply arrangement 600 of a radio receiver according to the present invention. The power supply 600 includes advantageously a low voltage battery 602 of which the voltage is converted into RF circuit supply voltage and tuning voltage with two separate step up converters. The first step up converter, 604 provides the RF circuit supply voltage, and the second step up converter, 608 provides the tuning voltage for the voltage controlled oscillator. The step-up converters 604, 608 can be turned on/off for example with “power switch” control signals. The power switch control signals can be received, for example, from a controller unit, which can also control the, demodulator 606 to on/off states with a further power switch signal or through the I2C bus.

The low power integrated circuit (IC) 618 comprising the phase locked loop is connected directly to the stabilised low voltage battery 602, as well as the step up converters 604 and 608, and the demodulator 606. Other RF circuits and IC's are connected to the RF circuit supply voltage, generated in the RF circuit power supply step up converter 604 and the tuning voltage converter 608. During a data transmission break the DC step up converters 604 and 608 and the demodulator IC 606 are switched down from a separate power down pin in the IC's. All the devices connected to the RF circuit power supply, such as an RF amplifier 610, a controllable-gain AGC (Automatic Gain Control) amplifier 612, a mixer/oscillator IC 614 and an IF amplifier IC 616, are therefore switched off. The IC for the phase locked loop being connected directly to the battery power supply 602 remains ready to lock-in, in the transmission channel frequency. The demodulator retains all the previously used parameters such as the code rate, constellation, guard interval and channel estimation during the data transmission break.

The two step-up converters 604 and 608 can be controlled separately, so that either only the RF circuit power supply or both the RF circuit power supply and the tuning voltage power supply can be turned off during the data receive break. The phase locked loop integrated circuit can also be turned down (if this feature supported) from power down switch (IC pin) or via I2c-bus (software) during a longer transmission break. The step up converters can be switched from the demodulator IC, by using I/O-port. Step up converters can be controlled from a separate (power) controller or logic. However, the power may alternatively be switched from the demodulator IC, by e.g. using an I/O-port. The battery supply voltage as well as the demodulator input voltage is preferably low.

FIG. 7 illustrates a schematic chart of an exemplary arrangement 700 for controlling power consumption in a radio receiver according to the present invention. The arrangement comprises at least a radio receiver, a radio transmitting device and typical means for transmitting radio broadcast known from prior art and in addition the arrangement comprises means for transferring selected transport stream packets to said receiver in predetermined order. The transport stream packets are transferred advantageously in the predetermined order and periodically.

With an embodiment of the invention the arrangement 700 comprises means 702 for turning off power of at least part of the receiver for a period during the time between at least two selected transport stream packets, and means 704 for informing said receiver about when to receive at least one of the following selected transport stream packets. The arrangement 700 comprises also means 706 for transferring the transport stream packets to the receiver periodically. This can be achieved for example by a timing unit 706. In addition the arrangement 700 comprises transport stream packet generator or the like for generating selected transport stream packets and providing predetermined period of the transport stream packets or symbols.

In addition the arrangement 700 according to the invention comprises means 708, 710 for communicating the order or periodicity of the selected and transferred transport stream packets to the receiver. This can be performed for example by transferring related data in service information (SI) message or communicating the periodicity to the receiver on interaction channel 710. Alternatively the arrangement may comprise means 712 for detecting the periodicity automatically by the receiver using an intelligent algorithm. The arrangement comprises also means 714 for locking said receiver in to periodicity.

The construction of the control unit of the receiver is not described in a greater detail. In general, the functions in a telecommunication receiver are controlled by a controller including processing capacity in the form of microprocessor(s) and memory in the form of memory circuits. Such arrangements are known as such from the technology of the art. To convert a known telecommunication receiver into a telecommunication device according to the invention, it may be necessary in addition to the hardware changes described above, to store into the memory means a set of machine-readable instructions that instruct the microprocessor(s) of the receiver controller to perform the control operations described above. Composing and storing into memory of such instructions involves known technology which, when combined with the teachings of this patent application, is within the capabilities of a person skilled in the art.

Above, an example embodiment of the solution according to the invention has been described. The principle according to the invention can naturally be modified within the frame of the scope defined by the claims, for example, by modification of the details of the implementation and ranges of use.

Above, DVB-T receiver is used as an example. However, the present invention can naturally be applied, in receivers of any communications system where transmission is not continuous. One example of such a system is Digital Audio Broadcasting (DAB) and mobile telecommunications systems that use Time Division Multiple Access (TDMA) technology.

Above, some examples of values for parameters such as voltages are given. However, other alternative values depending on the circuit design can naturally be applied.

The invention has been explained above with reference to the aforementioned embodiments, and several advantages of the invention have been demonstrated. It is clear that the invention is not only restricted to these embodiments, but comprises all possible embodiments within the scope of the inventive and the following patent claims.

1. A method for controlling power consumption in a radio receiver for receiving transport stream packets, wherein selected transport stream packets are transferred to said receiver in predetermined order, comprising the steps, where:
power of at least part of the receiver is turned off for a period during the time between at least two selected transport stream packets, and
said receiver is informed about when to receive at least one of the following selected transport stream packets.

2. A method according to claim 1, wherein said receiver is informed about the order, in which to receive the selected transport stream packets.

3. A method according to claim 1, wherein the transport stream packets are sent to the receiver periodically, where said period is time based or data content based.

4. (Cancelled)

5. (Cancelled)

6. A method according to claim 1, wherein transport stream packet is generated by a time generator for providing predetermined period of the transport stream packets or for providing predetermined period of the symbols.

7. (Cancelled)

8. A method according to claim 1, wherein the periodicity is communicated to the receiver by at least one datagram by related data in service information (SI), or on interaction channel.

9. (Cancelled)

10. (Cancelled)

11. A method according to claim 1, wherein periodicity is detected automatically by the receiver using an intelligent algorithm.

12. A method according to claim 1, wherein said receiver is locked-in to periodicity.

13. A method according to claim 1, wherein the packet level power controlling scheme is utilized after RF and other Orthogonal Frequency Division Multiplex (OFDM) modulator parts.

14. A method according to claim 1, wherein the part of the receiver turned off/on is at least one of the following: controlling means of RF parts, digital parts of the front-end, controlling means of demultiplexer, microprocessor, media decoder, display and entire receiver terminal.

15. An arrangement for controlling power consumption in a radio receiver for receiving transport stream packets, wherein the arrangement comprises radio transmitting arrangement and radio receiver and means for transferring selected transport stream packets to said radio receiver in predetermined order, the arrangement comprising
means for turning off power of at least part of the receiver for a period during the time between at least two selected transport stream packets, and
means for informing said receiver about when to receive at least one of the following selected transport stream packets.

16. An arrangement according to claim 15, wherein the arrangement comprises means for informing said receiver about the order, in which to receive the selected transport stream packets.

17. An arrangement according to claim 15, wherein the arrangement comprises means for transferring the transport stream packets to the receiver periodically.

18. An arrangement according to claim 15, wherein the arrangement is adapted to generate the transport stream packets by time generator for providing predetermined period of the transport stream packets or for providing predetermined period of the symbols.

19. (Cancelled)

20. An arrangement according to claim 15, wherein the arrangement comprises means for communicating the periodicity to the receiver by at least one datagram by related data in service information (SI), or on interaction channel.

21. (Cancelled)

22. An arrangement according to claim 15, wherein the arrangement comprises means (for detecting the periodicity automatically by the receiver using an intelligent algorithm.

23. An arrangement according to claim 15, wherein the arrangement comprises means for locking said receiver in to periodicity.

24. An arrangement according to claim 15, wherein the arrangement comprises means for utilising the packet level power controlling scheme after RF and other Orthogonal Frequency Division Multiplex (OFDM) modulator parts.

25. A radio transmission arrangement for generating transport stream packets and transferring them in a predetermined order to a receiver, wherein a radio transmission arrangement comprises means for transferring selected transport stream packets to said receiver in the predetermined order, the radio transmission arrangement comprising
means for informing said receiver about the order, when to receive at least one of the following selected transport stream packets.

26. A radio transmission arrangement according to claim 25, wherein said order is periodic and said arrangement comprises means for communicating the periodicity to said receiver.

27. A radio transmission arrangement (according to claim 25, wherein said arrangement comprises means for communicating the periodicity to said receiver by at least one datagram, by related data in service information (SI), or on interaction channel.

28. (Cancelled)

29. (Cancelled)

30. A radio transmission arrangement according to claim 25, wherein said arrangement comprises transport stream packets generator for generating transport stream packets and for providing the predetermined period of the transport stream packets, or providing the predetermined period of the symbols.

31. (Cancelled)

32. A radio transmission arrangement according to claim 25, wherein said arrangement comprises means for the transferring transport stream packets to the receiver periodically.

33. A radio transmission arrangement according to claim 25, wherein said arrangement (is arranged to provide periodicity based on time, or on data content.

34. (Cancelled)

35. A radio receiver for receiving transport stream packets, wherein said radio receiver is arranged to receive selected transport stream packets in predetermined order, the radio receiver comprising
means for receiving information about when to receive at least one of the following selected transport stream packets, and
means for turning off power of at least part of the receiver for a period during the time between at least two selected transport stream packets.

36. A radio receiver according to claim 35, wherein said receiver comprises means for receiving the communication concerning the periodicity of the selected transport stream packets to be received.

37. A radio receiver according to claim 35, wherein said receiver is arranged to receive transport stream packets in time based period, or in data content based period.

38. (Cancelled)

39. A radio receiver according to claim 35, wherein said receiver comprises means for receiving the communication concerning the periodicity by at least one datagram, by related data in service information (SI) message, or from interaction channel.

40. (Cancelled)

41. (Cancelled)

42. A radio receiver according to claim 35, wherein said receiver comprises means for detecting the periodicity automatically by using an intelligent algorithm.

43. A radio receiver according to claim 35, wherein said receiver comprises means for locking-in to the periodicity.

44. A radio receiver according to claim 35, wherein said receiver is DVB receiver.

45. A computer program product for controlling power consumption in a radio receiver for receiving transport stream packets, wherein selected transport stream packets are transferred to said receiver in predetermined order, comprising:
computer program code for turning off power of at least part of the receiver for a period during the time between at least two transport stream packets, and
computer program code for informing said receiver when to receive at least one of the following selected transport stream packets.
